(19) United States
(12) Patent Application Publication
(10) Pub. No.: US 2026/0343522 A1
(43) Pub. Date: Oct. 29, 2026

(54) WIRELESS COMMUNICATION METHOD AND RELATED DEVICES

(71) Applicant: SHENZHEN TCL NEW TECHNOLOGY CO., LTD., Shenzhen, Guangdong (CN)

(72) Inventor: Yiwei DENG, Shenzhen, Guangdong (CN)

(73) Assignee: SHENZHEN TCL NEW TECHNOLOGY CO., LTD., Shenzhen, Guangdong (CN)

(21) Appl. No.: 19/157,348

(22) PCT Filed: Feb. 17, 2023
(86) PCT No.: PCT/CN2023/076928

§ 371 Date: Aug. 15, 2025

(51) Int. Cl. H04W 72/115

(52) U.S. Cl. CPC H04W 72/115

(57) ABSTRACT

A wireless communication method and related devices such as a user equipment (UE) and a base station (BS) (e.g., a gNB) are provided. The wireless method, performed by a UE, including being configured with multiple resources or transmission occasions (TOs) within a configured grant (CG) configuration which is used for transmitting more than one transport block (TB). With this method, a CG configuration with multiple transmission occasions is realized.

### TECHNICAL FIELD

The present application relates to wireless communication technologies, and more particularly, to a wireless communication method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB). LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

Extended Reality (XR) and Cloud Gaming are some of the most important 5G media applications under consideration in the industry. XR is an umbrella term for different types of realities and refers to all real-and-virtual combined environments and human-machine interactions generated by computer technology and wearables. It includes representative forms such as Augmented Reality (AR), Mixed Reality (MR) and Virtual Reality (VR) and the areas interpolated among them. A new Study Item Description (SID) on XR evaluation has been approved in 3GPP. The characteristics of XR traffic and challenges are summarized below:

High Data Rate with Limited Latency:

For 3D VR videos with high resolution based on different frame rates, color codecs, bit-depths, compression rates and etc., the transmission date rate could be up to 60 Mbps and above with limited latency, around 10~30 ms.

Non-Integer Period with Jitter:

It has been agreed that 60 frames per second (fps) is baseline for both Downlink (DL) and Uplink (UL) video stream and 30 fps, 90 fps as well as 120 fps can be also optionally evaluated. Based on the formula of arrival time of packet, the corresponding periodicities are 33.33 ms, 16.67 ms, 11.11 ms and 8.33 ms, respectively. In addition, there has jitter characteristic for XR traffic arrival. According to the previous 3GPP RAN1 agreements, the jitter can be modeled as truncated Gaussian distribution with varying range of [−4,4] ms (baseline) or [−5,5] ms (optional).

### Varying Frame Size:

In the field of video compression, three major frame types are defined through three different video algorithms with the following characteristics:
I-frames are the least compressible ones which can decode independently.
P-frames can use previous frames to decompress and are more compressible than I-frames.
B-frames can use both previous and forward frames to get the highest amount of data compression.

In current 3GPP RAN1 meetings, increasing the number of Configured Grant (CG) Physical Uplink Shared Channel (PUSCH) transmission occasions (TOs) in a duration has been discussed and several agreements have been reached on RAN1 #111 meeting. The agreements are shown below:
Agreement 1: Support dynamic indication of the unused CG PUSCH occasion(s) based on Uplink Control Information (UCI) (e.g., CG-UCI or a new UCI) by the UE.
Agreement 2: Support multiple CG PUSCH transmission occasions in a period of a single CG PUSCH configuration.

As the XR video traffic is periodically generated and has low latency requirement, it is beneficial to adopt CG resources for uplink (UL) XR video transmission. For XR video, the large frame size may require more than one PUSCHs to be transmitted in each video frame period. So more than one PUSCH transmission occasions within a CG configuration is beneficial for XR to handle the issue of varying frame size.

In 3GPP RAN #98 e-meeting, the scope of XR WI in 3GPP Release 18 was approved and shown in the following:

Specify the enhancements related to power saving:
DRX support of XR frame rates corresponding to non-integer periodicities (through at least semi-static mechanisms e.g., RRC signalling) (RAN2).

Specify the enhancements related to capacity:
Multiple CG PUSCH transmission occasions in a period of a single CG PUSCH configuration (RAN1, RAN2).
Dynamic indication of unused CG PUSCH occasion(s) based on UCI by the UE (RAN1).
BSR enhancements including at least new BS Table(s); (RAN2).
Delay reporting of buffered data in uplink; (RAN2).
Provision of XR traffic assistance information for DL and UL (e.g. periodicity); (RAN2).
Discard operation of PDU Sets (RAN2).

Specify the enhancements for XR Awareness (RAN2, RAN3): TBD (detailed objectives will be further clarified at RAN #99 based on the conclusions of TR38.835, and work to be started only after RAN #99).

However, there are still some issues needed to be addressed for configuring multiple transmission occasions in a CG configuration.

### Other Related Arts

In current 3GPP specification, an IE of ConfiguredGrantConfig is used to configure uplink transmission without dynamic grant according to two possible schemes. The actual uplink grant may either be configured via RRC (type1) or provided via the PDCCH (addressed to CS-RNTI) (type2). Multiple Configured Grant configurations may be configured in one BWP of a serving cell and the maximum number of CG configurations are 12.

For type 2, a UE validates, for scheduling activation or scheduling release, a DL SPS assignment PDCCH or a configured UL grant Type 2 PDCCH if:
the CRC of a corresponding DCI format is scrambled with a CS-RNTI provided by cs-RNTI or a G-CS-RNTI provided by g-cs-RNTI.
and—the new data indicator field in the DCI format for the enabled transport block is set to ‘0’.
and—the DFI flag field, if present, in the DCI format is set to ‘0’.
and—the time domain resource assignment field in the DCI format indicates a row with single SLIV.
and—if validation is for scheduling activation and if the PDSCH-to-HARQ_feedback timing indicator field in the DCI format is present, the PDSCH-to-HARQ_feedback timing indicator field does not provide an inapplicable value from dl-DataToUL-ACK-r16.

If a UE is provided a single configuration for UL grant Type 2 PUSCH or for SPS PDSCH, validation of the DCI format is achieved if all fields for the DCI format are set correspondingly.

If a UE is provided more than one configuration for UL grant Type 2 PUSCH or for SPS PDSCH, a value of the HARQ process number field in a DCI format indicates an activation for a corresponding UL grant Type 2 PUSCH or for a SPS PDSCH configuration with a same value as provided by ConfiguredGrantConfigIndex or by sps-ConfigIndex, respectively. Validation of the DCI format is achieved if the RV field for the DCI format is set correspondingly.

If a UE is provided more than one configuration for UL grant Type 2 PUSCH or for SPS PDSCH:
if the UE is provided ConfiguredGrantConfigType2DeactivationStateList or sps-ConfigDeactivationStateList, a value of the HARQ process number field in a DCI format indicates a corresponding entry for scheduling release of one or more UL grant Type 2 PUSCH or SPS PDSCH configurations.
if the UE is not provided ConfiguredGrantConfigType2DeactivationStateList or sps-ConfigDeactivationStateList, a value of the HARQ process number field in a DCI format indicates a release for a corresponding UL grant Type 2 PUSCH or for a SPS PDSCH configuration with a same value as provided by ConfiguredGrantConfigIndex or by sps-ConfigIndex, respectively.

Validation of the DCI format is achieved if all fields for the DCI format are set correspondingly.

If validation is achieved, the UE considers the information in the DCI format as a valid activation or valid release of DL SPS or configured UL grant Type 2. If validation is not achieved, the UE discards all the information in the DCI format.

With current mechanism, a single CG configuration and multiple CG configurations can be configured. A DCI or multiple DCIs can be used to activate or deactivate one or more CG configurations. In addition, repetition can be configured in a CG configuration, and two types of PUSCH transmission are defined, in which one is type A PUSCH repetition and the other is type B PUSCH repetition. Type A PUSCH repetition is based on slot and with at most one repetition within a slot, and the time and frequency of each CG configuration within a slot is the same. For type B PUSCH repetition, the repetition pattern is back-to-back in time domain, and more than one repetitions can be configured within a slot.

### SUMMARY

The objective of the present application is to provide a wireless communication method and related devices, for realizing multiple transmission occasions (TOs) within a CG configuration.

In a first aspect, an embodiment of the present application provides a wireless communication method, performed by a user equipment (UE), the method including: being configured with multiple resources or transmission occasions (TOs) within a configured grant (CG) configuration which is used for transmitting more than one transport block (TB).

In a second aspect, an embodiment of the present application provides a wireless communication method, performed by a base station (BS), the method including: configuring a user equipment (UE) with multiple resources or transmission occasions (TOs) within a configured grant (CG) configuration which is used for transmitting more than one transport block (TB).

In a third aspect, an embodiment of the present application provides a user equipment (UE), including a processor, a transceiver and a memory, wherein the processor, the transceiver and the memory communicate with each other through an internal connection path, the memory is used for storing instructions, and the processor is used for, when executing the instructions stored in the memory, executing the method of the first aspect.

In a fourth aspect, an embodiment of the present application provides a base station (BS), including a processor, a transceiver and a memory, wherein the processor, the transceiver and the memory communicate with each other through an internal connection path, the memory is used for storing instructions, and the processor is used for, when executing the instructions stored in the memory, executing the method of the second aspect.

In a fifth aspect, an embodiment of the present application provides a computer readable storage medium provided for storing a computer program, which enables a computer to execute the method of any of the first and the second aspects.

In a sixth aspect, an embodiment of the present application provides a computer program product, which includes computer program instructions enabling a computer to execute the method of any of the first and the second aspects.

In a seventh aspect, an embodiment of the present application provides a computer program, when running on a computer, enabling the computer to execute the method of any of the first and the second aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating a CG configuration with multiple TOs for a periodic XR packet.

FIG. 2 is a schematic diagram illustrating varying XR frame size and semi-statically configured CG resources.

FIG. 3 is a schematic diagram illustrating varying packet size and jitter for XR with CG.

FIG. 4 is a block diagram of a user equipment and a base station of wireless communication in a communication controlling system according to an embodiment of the present application.

FIG. 5 is a schematic diagram illustrating radio protocol architecture within gNB and UE.

FIG. 6 is a schematic diagram illustrating a gNB further including a centralized unit (CU) and a plurality of distributed unit (DUs).

FIG. 7 is a flowchart of a wireless communication method according to an embodiment of the present application.

FIG. 8 is a schematic diagram illustrating an example of multiple TB repetitions transmitted over multiple TOs.

FIG. 9 is a schematic diagram illustrating another example of multiple TB repetitions transmitted over multiple TOs.

FIG. 10 is a schematic diagram illustrating TB collision with other transmission.

FIG. 11 is a schematic diagram illustrating multiple HARQ-IDs for multiple TOs within a CG configuration.

FIG. 12 is a schematic diagram illustrating UCI indicating un-used TOs within a CG configuration.

### DETAILED DESCRIPTION OF EMBODIMENTS

Embodiments of the application are described in detail with the technical matters, structural features, achieved objects, and effects with reference to the accompanying drawings as follows. Specifically, the terminologies in the embodiments of the present application are merely for describing the purpose of the certain embodiment, but not to limit the application.

In this document, the term “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and 30 C, B and C, or A and B and C, where any combination may contain one or more members of A, B, or C.

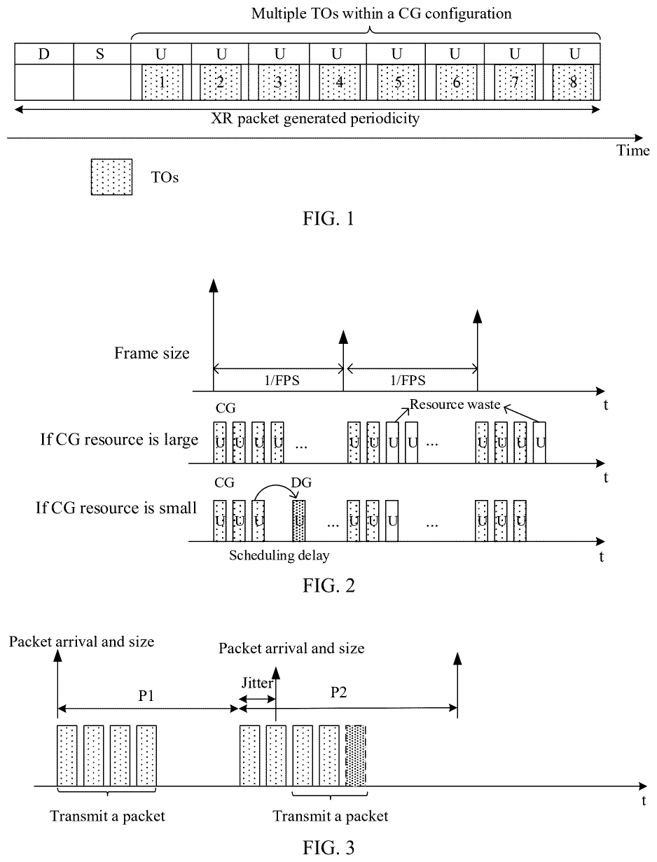

At the early stage of power saving, to handle the issue of varying packet size of XR when configured grant (CG)/semi-persistent scheduling (SPS) and discontinuous reception (DRX) are configured to a UE, the resources of a CG or SPS may not be enough to transmit packets. Therefore, some companies propose to add extra PDCCH monitoring occasion(s) after CG/SPS during DRX off state. In addition, for DRX itself, when the DRX duration is not enough (due to jitter or varying packet size) to handle a packet, an additional in-active time will be needed. When a XR packet is finished during a DRX duration, whether the remaining duration is needed should be handled. In this regard, some companies propose to skip the remaining time of DRX duration. However, some companies argues that the mechanism of PDCCH adaption in 3GPP Release17 can be used to handle this case as long as the value of PDCCH skipping is suitable, and it is deemed that there is no need to skip the remaining time of DRX duration. For capacity enhancements of XR, there are similar issues. In the aspect of capacity enhancements, because of low latency of XR, for UL transmission, a primary task is to develop a suitable transmission mechanism of XR, DG based transmission or CG based transmission. At the early stage of XR capacity enhancements, DG based, CG+DG based, SR+DG based, pre-scheduling or enhanced CG based mechanism for XR transmission have been proposed. After several 3GPP meetings, many companies have agreed that the enhanced CG can be considered as a potential method for XR transmission due to its low alignment latency and can work on DRX-off state. However, when both the jitter and varying packet size of XR are considered, the current CG mechanism is not suitable for XR transmission. Accordingly, a further CG enhancement is needed. To match the XR traffic, especially for the varying large packet size, multiple CG occasions configured for a CG can be considered, as shown in FIG. 1.

However, more details about the multiple TOs configured in a CG configuration have not been discussed and decided yet.

One of the issues is how a UE works based on the mechanism of a CG configuration with multiple TOs, and relevant issues are listed in the following:

When multiple TOs are configured within a CG configuration, how to indicate the number of TOs within a CG configuration to UE is needed in order to avoid ambiguity between gNB and UE.

How to configure/determine time domain resources for multiple TOs within a CG configuration. Whether to support TOs with repetition or not should be considered and types of TOs (type A or Type B, back-to-back mapping, collision in time domain, and so on) should also be considered.

In current 3GPP specification, the HARQ-ID of a CG is calculated based on a formula, and the HARQ process field in DCI is used for activation of a CG. However, for XR, the multiple TOs need to transmit more than one TB. When a TB is not successfully transmitted over a TO, re-transmission is needed. In current 3GPP specification, the HARQ-IDs of TOs will be collided. How to determine the HARQ-IDs for all of the TOs within a CG configuration to avoid collision should be studied.

In current 3GPP specification, a set of allowed periodicities P are defined in TS 38.331. The higher layer parameter cg-nrofSlots provides the number of consecutive slots allocated within a configured grant period. The higher layer parameter cg-nrofPUSCH-InSlot provides the number of consecutive PUSCH allocations within a slot, where the first PUSCH allocation follows the higher layer parameter timeDomainAllocation for Type 1 PUSCH transmission or the higher layer configuration according to TS 38.321, and UL grant is received on the DCI for Type 2 PUSCH transmissions, and the remaining PUSCH allocations have the same length and PUSCH mapping type and are appended following previous allocations without any gaps.

However, the CG resource is semi-statically configured, which cannot adapt to the varying size of XR packet. As illustrated in FIG. 2, if 4 PUSCHs in one CG period are configured, there will be a waste of resources for the video frames that need less than 4 PUSCHs. If 3 PUSCHs in one CG period are configured and if the video frames are large, e.g., 4 PUSCHs are required for each video frame, then additional dynamic scheduling is needed, resulting in extra scheduling delay.

In addition, when packet arrival is late due to jitter, the TOs within a CG configuration may not be enough, and this will cause extra latency. As shown in the FIG. 3, due to jitter, the packet arrived in P2 is later than a predicted location and there are only two available TOs (which are less than actual demand). This will also cause a scheduling delay as that shown in FIG. 2. Therefore, how to indicate un-used TOs and additional TOs is needed.

How to indicate the un-used and additional TOs with a CG configuration is needed. A signalling for indicating the un-used or additional TOs should be defined. In addition, when the signalling is defined, the mechanism in current 3GPP specification is not applicable, and how to define the multiplexing rules between the signalling and current UL control information should be considered.

In short, this application proposes methods to enable the CG configuration to support large and varying size of XR. The following solutions are provided:

To determine the number of TOs, the parameter of the number of repetitions of a CG can be reused for indicating the number of multiple TOs within a CG configuration which is used to transmit more than one TB, a new signalling or joint-coding with some parameters (e.g., TDRA) can be used to indicate the number of TOs within the CG configuration, and some implicit ways can be used to indicate the number of TOs within the CG configuration, e.g., the number of TDRA, periodicity of CG.

To indicate the HARQ-ID of each TO or each set of TOs, a semi-static method can be provided to determine the HARQ-IDs, and the HARQ-IDs can be determined based on a reference HARQ-ID plus a new parameter or some information of a TO and can be directly configured.

To indicate the un-used/additional TOs for a CG configuration to gNB, solutions using CG-UCI, new UCI and CAS are given, mainly including:
Sequence based: a set of values representative of un-used TOs can be configured by RRC, then the UCI is used to indicate a corresponding index (e.g. the UCI is similar to SR), and a default value (e.g., a default offset value) is defined to determine the time location of the un-used TOs.
Sequence based: a set of values representative of un-used TOs and a corresponding value K (e.g., an offset value) are configured by RRC, and then the UCI indicates a corresponding index.
Non-sequence based: a new UCI is carried by PUCCH, and the content of UCI includes at least one of the number of unused TOs, the value of K, or the index of unused TOs or a set of unused TOs, etc., where K is used to determine the time location of un-used TOs.
CG-UCI: the content of UCI includes at least one of the following parameters: the number of TOs, the value of K, or the index of a TO or a set of TOs, etc., where K is used to determine the time location of un-used TOs.
Bitmap: the size of this field is equal to the total number of TOs.

Furthermore, rules for new UCI and CG-UCI to multiplex with current types of UCI are also given.

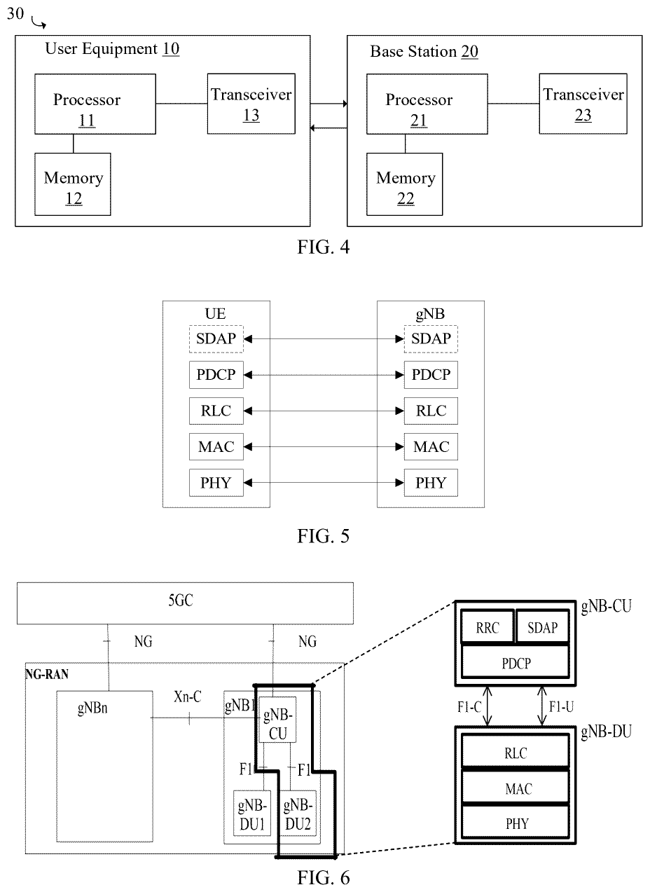

FIG. 4 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal. The base station 20 and a next generation core network (5GCN) may also communicate with each other either wirelessly or in a wired way. When the communication network system 30 complies with the New Radio (NR) standard of the 3rd Generation Partnership Project (3GPP), the next generation core network is a backend serving network system and may include an Access and Mobility Management Function (AMF), User Plane Function (UPF), and a Session Management Function (SMF). In one aspect, the user equipment 10 can include almost any consumer electronic device or appliance that can connect to a radio access network and a core network for the releases of 3GPP and further, such as, but not limited to NR networks.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art. The user plane radio protocol architecture within the gNB and UE is shown in FIG. 5, which includes optional Service Data Adaptation Protocol (SDAP), Packet Data Convergence Protocol (PDCP), Radio Link Control (RLC), Medium Access Control (MAC). In RAN functional split, a gNB further includes a centralized unit (CU) and a plurality of distributed unit (DUs) as shown in FIG. 6. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer and the RLC layer.

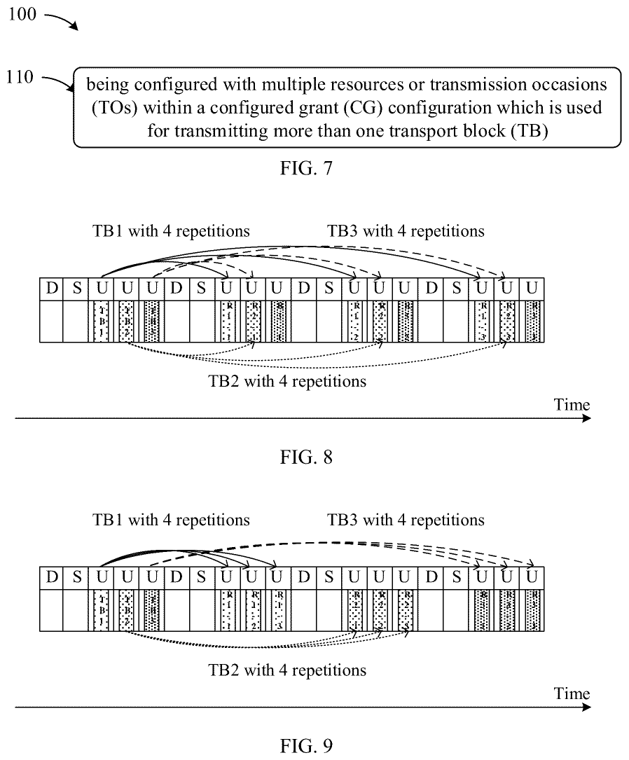

FIG. 7 illustrates a wireless communication method according to an embodiment of the present application. Referring to FIG. 7 in conjunction with FIG. 4, the method 100 includes the followings. In Step 110, the UE is configured by the base station (BS) (the BS configures the UE) with multiple resources or transmission occasions (TOs) within a configured grant (CG) configuration which is used for transmitting more than one transport block (TB). That is, there are multiple resources or TOs configured in a CG configuration for transmission of more than one TBs on Physical Uplink Shared Channel (PUSCH). The CG configuration can be a single CG configuration or one of multiple CG configurations. For the single CG configuration, one CG configuration is configured at one time. For the multiple CG configurations, more than one CG configurations are configured at one time. With this method, a CG configuration with multiple transmission occasions is realized.

In an embodiment, the number of repetitions of each TO may be used to determine the number of TOs within the CG configuration, and the UE may receive a signaling which is used to indicate that the number of repetitions of each TO is used to determine the number of TOs within the CG configuration. The signaling may be carried out by a field in downlink control information (DCI) or a column in a Time Domain Resource Allocation (TDRA) field of the DCI. In another embodiment, the number of TOs within the CG configuration may be indicated by Radio Resource Control (RRC), or by Medium Access Control (MAC) Control Element (CE), or by DCI, or by a TDRA field in DCI. In still another embodiment, the number of TOs within the CG configuration may be associated with at least one of the periodicity of CG, the duration of time domain of each TO, the type of Physical Uplink Shared Channel (PUSCH), the number of slots within the periodicity, or the number of repetitions of each TO.

In an embodiment, TBs transmitted over the TOs within the CG configuration are configured with repetition, initial transmissions of different TBs are transmitted first, and the repetition of all the different TBs is transmitted consecutively after the initial transmission in order. In another embodiment, TBs transmitted over the TOs within the CG configuration are configured with repetition, initial transmissions of different TBs are transmitted first, and all repetitions of one of the different TBs are transmitted consecutively after the initial transmission in order. In some embodiments, a frequency hopping may be used for all of the TOs per TB. In a case of collision, if some TBs or TOs are collided with another transmission, a set of supplement TOs are added after a last TO of the CG configuration. In a case of collision, if some TBs or TOs are collided with another transmission, the TB over the collided TO is moved to a next or next available TO or the TB over the collided TO is moved to a next or next available TO which carries the same TB.

In an embodiment, each of the TOs within the CG configuration may have a different HARQ-ID. Multiple HARQ-IDs are determined based on a first symbol of each TO of the CG configuration, or the HARQ-IDs of all the TOs within the CG configuration are determined based on a reference HARQ-ID and/or the index/number of a corresponding TO. In another embodiment, each set of TOs within the CG configuration may have a different HARQ-ID, and the HARQ-ID for the TOs within a same set is the same. Multiple HARQ-IDs are determined based on a first symbol of TOs within each set, or the HARQ-IDs of all of the sets of TOs within the CG configuration are determined based on a reference HARQ-ID and/or the index/number of each set of TOs.

In an embodiment, un-used or used TOs within the CG configuration are indicated by uplink control information (UCI) or CG-UCI or CAS. In an example, a set of values representative of the un-used TOs is configured by radio resource control (RRC), and the UCI or CG-UCI is used to indicate an index corresponding to one of the set of values representative of the un-used TOs. A default value may be defined to determine time location of the un-used TOs. In another example, UCI or CG-UCI includes at least one of the following parameters: the number of the unused TOs, a value of K, or an index of the unused TOs or a set of the unused TOs. In still another example, a bitmap is used to indicate the un-used TOs within the CG configuration. Furthermore, an extra bit in a field in the UCI or CG-UCI indicates the un-used TOs or used TOs which the UCI or CG-UCI is used to indicate, or indication of the un-used TOs or the used TOs is carried out by different UCIs or CG-UCIs.

In an embodiment, additional TOs are added after the last TO within the CG configuration. The additional TOs may be indicated by UCI or CG-UCI, which includes at least one of the following parameters: a reference TO, the number of TOs, a value of K, or an index of a TO.

In an embodiment, the CG-UCI may be connected with other CG-UCI when the CG-UCI and the other CG-UCI are overlapped in time domain. CG-PUSCH may carry the CG-UCI first and then carries other types of UCIs.

Further details on how to determine the resource and/or the number of transmission occasions (TOs) within a configured grant (CG) configuration are described as follows.

This disclosure proposes method(s) to determine the resource and/or the number of TOs within a CG configuration. More than one transport block (TB) can be transmitted over the multiple TOs within the CG configuration. CG with repetition is supported in current 3GPP specification. When a CG configured with repetition and the number of repetitions is large than 1, multiple transmission occasions can be used for transmitting an initial TB and its repetitions with or without a same redundancy version (RV). To avoid the ambiguity of the functions of the multiple TOs, some parameters can be reused or a new signalling can be introduced to indicate the number of TOs which are used for transmitting more than one TB.

In a first possible solution of the present application, all the parameters configured by Radio Resource Control (RRC) and/or Downlink control information (DCI) can be shared by multiple TOs within a CG configuration. The parameter of the number of repetitions of a CG configuration can be reused for determining the number of the multiple TOs within the CG configuration which is used for transmitting more than one TB. A new signalling can be introduced to enable or disable this function. The signalling can be an RRC or Medium Access Control (MAC) Control Element (CE) or DCI signalling, for example. When the number of repetitions of a CG configuration is indicated by a Time Domain Resource Allocation (TDRA) field in DCI, a new field in DCI or a new column in TDRA can be used to indicate whether the number of repetitions can be reused to determine the number of TOs within a CG configuration. For example, the new field or the new column is 1 bit, and bit “1” or “0” indicates the number of repetitions is used to determine the number of TOs.

In a second possible solution of the present application, all the parameters configured by RRC and/or DCI can be shared by multiple TOs within a CG configuration. In order to achieve the reliability of a set of PUSCHs or TBs transmitted over multiple TBs, repetition is needed but the number of repetitions should not be used to determine the number of TOs. The number of TOs within a CG configuration can be indicated by a new signalling or indicated by cooperating with a current parameter. A new RRC or MAC CE or DCI can be introduced for indicating the number of TOs within a CG configuration. The number of TOs within a CG configuration can also be indicated by TDRA. A new column can be added into the TDRA table to indicate the number of TOs within a CG configuration. When the number of repetitions (its value is k) is also presented, each TO with k repetitions is enabled. In some embodiments, the number of TOs within a CG configuration means a same number of TBs/PUSCHs that are transmitted over the multiple TOs.

In a third possible solution of the present application, not all the parameters configured by RRC and/or DCI are shared by multiple TOs within a CG configuration. In order to achieve the flexibility of TOs, a part of parameters of the TOs are not shared. At least one of TDRA, modulation coding scheme (MCS) or RV can be configured independently among the multiple TOs. Each set of TDRAs, MCSs and RVs can be of a joint code-point (where a code-point can be used to indicate a set of TDRAs, MCSs, RVs or HARQ-IDs). In this way, the number of TDRAs, MCSs, RVs or hybrid automatic repeat request identifications (HARQ-IDs) can be used to indicate the number of TOs within a CG configuration.

In a fourth possible solution of the present application, the number of TOs within a CG configuration is associated with at least one of the periodicity of CG, the duration of time domain of each TO, the type of Physical Uplink Shared Channel (PUSCH), the number of slots within the periodicity, or the number of repetitions of each TO. For instance, when the PUSCH is configured as type A, the total number of TOs is equal to the number or available number of slots of one cycle or period of the CG. When the PUSCH is configured as Type B, the total number of TOs is equal to: ceil or floor ((the total number of symbols or available symbols of one cycle or period of the CG) divides (the time domain duration of a TO)).

The above embodiments realize determination on the resource and/or the number of TOs within a CG configuration which is used to transmit more than one TB, this avoids ambiguity between gNB and UE, and such a CG enhancement can be implemented for XR applications, for example.

Further details on how to determine the time/frequency pattern of multiple TOs within a CG configuration are described as follows.

This disclosure proposes method(s) to determine the time/frequency pattern of multiple TOs within a CG configuration and handle the case that a TB is collided with other transmission. When multiple TOs configured within a CG configuration is adopt for XR in 3GPP Release 18 or in later releases, to guarantee the reliability of PUSCH transmission, a straightforward way would be to enable repetition of a TB or a PUSCH transmission. In order to reduce the latency of packet transmission, the time repetition pattern based on TB can be considered, as that shown in FIG. 8 and FIG. 9 respectively.

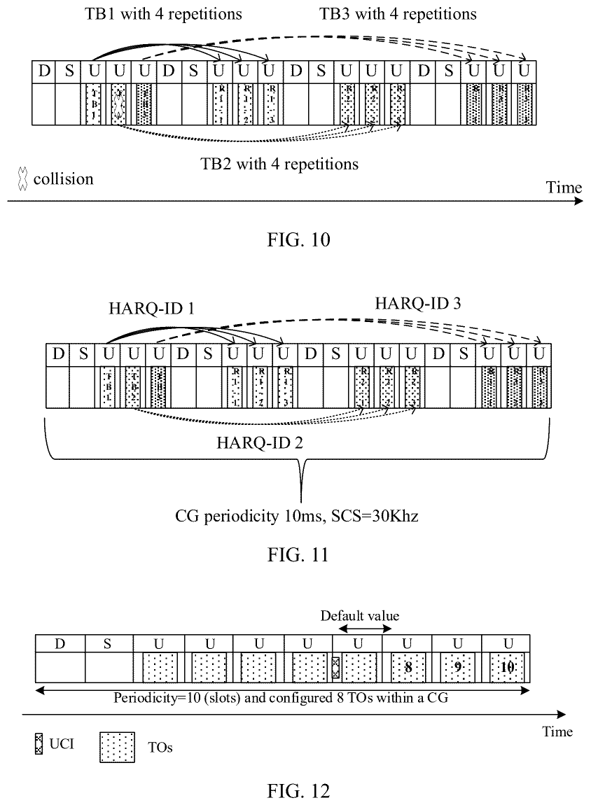

An example of time domain pattern for multiple TBs transmitted over multiple TOs within a CG configuration is shown in FIG. 8. In this example, when TBs transmitted over the TOs within the CG configuration are configured with repetition, different TBs of an initial transmission are transmitted first, and a repetition of all the different TBs is transmitted consecutively after the initial transmission. It is assumed that there are 3 TBs transmitted over multiple TOs within a CG configuration, denoted as TB1, TB2 and TB3. Different TBs (i.e., TB1, TB2, TB3) of initial transmission can be mapped to the TOs first, then the first repetition (i.e., R1-1, R2-1, R3-1) of the different TBs, then the second repetition (R1-2, R2-2, R3-2) of the different TBs . . . , and the repetitions are configured in this way. In other words, the rule for the TBs to map to the TOs is based on the following: 1. mapping the initial transmission of all the TBs first; 2. mapping the first repetition of all the TBs, and mapping the remaining repetitions of all the TBs in the same way. It is noted that TB1 in the figures means the first transmission or initial transmission, and R1-1, R1-2, R1-3 means the repetitions of the TB1; TB2 in the figures means the first transmission or initial transmission, and R2-1, R2-2, R2-3 means the repetitions of the TB2. The remaining TBs (e.g., TB3) are defined in a similar fashion. In addition, this definition is also applicable to FIG. 9, FIG. 10 and FIG. 11.

Another example of time domain pattern for multiple TBs transmitted over multiple TOs within a CG configuration is shown in FIG. 9. In this example, when TBs transmitted over the TOs within the CG configuration are configured with repetition, different TBs of an initial transmission are transmitted first, and all repetitions of one of the different TBs are transmitted consecutively after the initial transmission. It is assumed that there are 3 TBs transmitted over multiple TOs within a CG configuration, denoted as TB1, TB2 and TB3. Different TBs (i.e., TB1, TB2, TB3) of initial transmission can be mapped to the TOs first, then all the repetitions (i.e., R1-1, R1-2, R1-3) of the first TB, then all the repetitions (i.e., R2-1, R2-2, R2-3) of the second TB . . . , and the repetitions are configured in this way. In other words, the rule for the TBs to map to the TOs is based on the following: 1. mapping the initial transmission of all the TBs first; 2. mapping all of the repetitions of a TB based on the TB's order from the smallest to the largest.

In some embodiments, the frequency hopping rule is used for all of the TOs within the CG configuration, wherein the hopping can be inter-slot hopping, inter-TO hopping, inter-TB hopping or intra-slot hopping. In some embodiments, the frequency hopping rule is used for all of the TOs within the CG configuration based on a time duration of a TB, wherein the hopping can be inter-slot hopping, inter-TO hopping, inter-TB hopping or intra-slot hopping. Taking the inter-TO hopping for example (based on FIG. 8), when the inter-TO hopping is enabled and the number of hops is 2, the first hop includes {TB1, R1-2} and the second hop includes {R1-1, R1-3}. The frequency resources for the TOs within a same hop is the same, and there is a frequency offset between different hops.

Furthermore, when collision occurs on the multiple TOs within the CG configuration, some rules to handle the collision will be needed.
Case 1: In a case that multiple TBs without repetition transmitted over multiple TOs within a CG configuration, if some TBs or TOs are collided with another transmission, a set of supplement TOs can be added after a last TO of the CG configuration, and the parameters of configured TOs or a reference TO may share with the supplement TO, wherein the reference TO is pre-defined or indicated by UE or gNB. In some embodiments, the addition of the supplement TO(s) can be indicated by a uplink control information (UCI) or demodulation reference signal (DMRS). In some embodiments, the HARQ-ID of the supplement TO is the same as that of the TO which is collided with another transmission.
Case 2: In a case that multiple TBs with repetition transmitted over multiple TOs within a CG configuration, if some TBs or TOs are collided with another transmission, the TB over the collided TO can be moved to the next or next available TO or the TB over the collided TO can be moved to the next or next available TO which carries the same TB. For instance, as shown in FIG. 10, it is assumed that there are 3 different TBs each with 3 repetitions (not including the initial transmission) transmitted over multiple TOs within a CG configuration, and the RV cycling for each TB is {0,2,3,1}. The initial transmission of the TBs (e.g., TB2) is collided with another transmission. Then, the initial transmission of TB2 can be moved to the position of R2-1. The corresponding RV cycling may be: TB2's (at the position of R2-1) RV is 0, R2-2's RV is 3, and R2-3's RV is 1. In some embodiments, the initial TB2 can be moved to the nearest TO or nearest available TO which carries a repetition, and the RV of the TO is the same as the RV of the initial TB. For example, the initial TB2 can be moved to the R1-1, and the original R1-1 and all of the remaining repetitions can be postponed to the next TOs or the R1-1 is dropped.

The above embodiments realize determination on the time/frequency pattern of multiple TOs within a CG configuration which is used to transmit more than one TB and a handle of the case that a TB is collided with other transmission, this enables repetition of a TO or TB within the CG configuration, and such a CG enhancement can be implemented for XR applications, for example.

Further details on how to determine the HARQ-IDs of all of the TOs within a CG configuration are described as follows.

This disclosure proposes method(s) to determine the resource/transmission occasions within a CG configuration and mainly focuses on a semi-static way to determine the HARQ-IDs of all of the TOs within the CG configuration, especially for a case of the TOs with repetition. For the multiple TOs able to be used to transmitting more than one TBs, the HARQ-ID for each TO or each set of TOs has to be different in order to avoid the ambiguity between UE and gNB for re-transmission.
Case 1: In a case of the HARQ-ID for multiple TOs without repetition, each of the TOs has a different HARQ-ID. In current 3GPP specification, HARQ-ID of a CG is calculated based on the time location of the first transmission occasion of a CG, represented by the following formula:

HARQ Process ID=[floor(CURRENT_symbol/periodicity)]modulo nrofHARQ-Processes+harq-ProcID-Offset2 (1).

To realize multiple HARQ-IDs for multiple TOs within a CG configuration, the HARQ-IDs are calculated by reusing the formula of the current 3GPP specification, but the first symbol is not based on the first TO of the CG configuration. Instead, the first symbol is based on the first symbol of each TO of the CG configuration. The multiple HARQ-IDs can be calculated based on the first symbol of each TO of the CG configuration, or a reference HARQ-ID can be calculated based on current 3GPP specification and the HARQ-IDs of all the TOs are determined based on the reference HARQ-ID and are associated with a configured parameter or time/frequency resource or time/frequency resource location or the number of TOs or the index of TOs. In some embodiments, the HARQ-IDs for all the TOs can be configured by RRC or MAC CE or DCI directly, and in this case the number of different HARQ-IDs is equal to the number of TOs.
Case 2: In a case of the HARQ-ID for multiple TOs with repetition, each set of TOs has a different HARQ-ID, and the HARQ-ID for the TOs within a same set is the same, wherein a set of TOs transmit the same TB with or without repetition. For instance, as shown in FIG. 11, it is assumed that there are 3 TBs each with 3 repetitions (not including the initial transmission) transmitted over multiple TOs within a CG configuration. TB1 is transmitted over {TB1, R1-1, R1-2, R1-3}, TB2 is transmitted over {TB2, R2-1, R2-2, R2-3}, and TB3 is transmitted over {TB3, R3-1, R3-2, R3-3}. {TB1, R1-1, R1-2, R1-3} is defined as TO set 1, {TB2, R2-1, R2-2, R2-3} is defined as TO set 2, and {TB3, R3-1, R3-2, R3-3} is defined as TO set 3. In this way, HARQ-IDs for set 1, set 2 and set 3 are different, and the HARQ-ID for a set (e.g., set1, set2 or set3) is the same.

To realize multiple HARQ-IDs for multiple sets of TOs within a CG configuration, the HARQ-IDs are calculated by reusing the formula of the current 3GPP specification, but the first symbol is not based on the first TO of the CG configuration. Instead, the first symbol is based on the first symbol of a set of TOs. The multiple HARQ-IDs can be calculated based on the first symbol of a set of TOs or a reference HARQ-ID can be calculated based on current 3GPP specification and the HARQ-IDs of all of the sets of TOs are determined based on the reference HARQ-ID and are associated with a configured parameter or first time/frequency resource of the sets of TOs or first time/frequency resource location of the sets of TOs or the number of sets of TOs or the index of the sets of TOs. In some embodiments, the HARQ-ID for all sets of TOs can be configured by RRC or MAC CE or DCI directly, and in this case the number of different HARQ-IDs is equal to the number of sets of TOs.

The above embodiments realize determination on the HARQ-IDs for all of the TOs within a CG configuration which is used to transmit more than one TB, this resolves HARQ-IDs used between gNB and UE and avoids HARQ-ID collision, and such a CG enhancement can be implemented for XR applications, for example.

Further details on how to indicate the un-used TOs within a CG configuration are described as follows.

This disclosure proposes method(s) to indicate the un-used TOs within a CG configuration by CG-UCI or new UCI. In current 3GPP specification, UCI can be reported in physical uplink control channel (PUCCH), mainly including HARQ-ACK information, scheduling request (SR), link recovery request (LRR), channel state information (CSI) and CG-UCI, in which UCI bits include HARQ-ACK information bits (if any), SR information bits (if any), LRR information bit (if any) and CSI bits (if any). When the above UCI is overlapped in time domain, a multiplexing rule has to be determined. Besides, UCI can also be reported in physical uplink shared channel (PUSCH), a set of offset values are defined for a UE to determine a number of resources for multiplexing HARQ-ACK information and for multiplexing CSI reports in a PUSCH. Offset values (beta offset) are also defined for multiplexing CG-UCI in a CG-PUSCH. In LTE-LAA, to support adaptive re-transmission, CG-UCI (AUL-UCI, which is also referred to CG-UCI) has been approved. CG-UCI mainly includes HARQ-ID, RV-ID, new data indicator (NDI), etc. Similar mechanism of LTE-LAA is reused for 5G NR in unlicensed spectrum (NR-U), and the content for CG-UCI in NR-U includes: HARQ-ID, RV-ID, NDI, channel occupancy time (COT), etc. To avoid a wasting of resource, new UCI and CG-UCI can be used to indicate the un-used TOs.
Case 1: In a case that several consecutive TOs in a start portion within a CG configuration are un-used TOs, the packet for a traffic is not arrived at the expectant location in time domain due to jitter, and thus some TOs in a start portion within a CG configuration are not used.

In a first possible solution of the present application, if RAN2 (which develop XR-awareness or other topics) study the jitter measurement or varying packet size distribution and do some prediction, then a UE can skip a set of consecutive TOs in a start portion of CG. In this case, a new type of UCI carried on PUCCH is needed, the contents of the new UCI can be as follows:
Sequence based: a set of values representative of un-used TOs can be configured by RRC, then the UCI is used to indicate a corresponding index, and a default value (e.g., a default offset value) is defined to determine the time location of the un-used TOs. The default value can be pre-defined, and it is a time unit based on granularity of symbol or slot or duration of a TO or ms. In some embodiments, the default value can be the processing time for gNB to handle of the signalling transmitted by UE. In some embodiments, the remaining TOs located behind the duration from the first symbol or last symbol or the slot of the UCI to the length of default value within a CG period are indicated as un-used TOs.
Sequence based: a set of values representative of un-used TOs and a corresponding value K (e.g., an offset value) are configured by RRC, and then the UCI is used to indicate a corresponding index. The value of un-used TOs means the number of consecutive or non-consecutive TOs. The value of K is a time unit, and the granularity of the time unit can be slot, symbol, TO duration or ms. It means, from the time location of the signalling, a set of un-used TOs are indicated after K.
Non-sequence based: the content of UCI includes at least one of the following parameters: the number of unused TOs, the value of K, or the index of unused TOs or a set of unused TOs, where K is used to determine the time location of un-used TOs. The number of TOs means the number of consecutive or non-consecutive TOs. The number of TOs are used to determine the number of un-used TOs. The value of K is a time unit, and the granularity of the time unit can be slot, symbol, TO duration or ms. It means, from the time location of the signalling, a set of un-used TOs are indicated after K. In this case, the resources of the PUCCH should match the XR periodicity.
Bitmap: the size of this field is equal to the total number of TOs.

In a second possible solution of the present application, a matched UCI indicates next consecutive un-used TOs within a CG configuration when the UE buffer has no data. If traffic data arrive before one TO within a CG configuration, then a UCI can be transmitted to indicate that next consecutive TOs within a CG configuration are used. In this way, a set of PUCCHs need to be configured for indicating the un-used and used TOs within the CG configuration since there is no predicted information about packet size or jitter on UE side. A trade-off between overhead of PUCCH and resource saving for the TOs within a CG configuration needs to be evaluated. In addition, to distinguish the UCI which is used for indication of un-used or used TOs, either an extra bit in a field in UCI is need or more than one type of UCIs need to be designed.

In a third possible solution of the present application, a Channel Associated Signalling (CAS) within a CG configuration is introduced to indicate the un-used TOs in a start portion of the CG. The CAS is associated with a CG, and a specific resource within a CG or associated with a CG can be configured, and then the information for indicating the un-used TO is carried by the resource by PUSCH, MAC CE, UCI or other UL channels.
Case 2: Several consecutive TOs in an end portion of a CG configuration are un-used TOs. This case is the initial motivation to support the function of indication of un-used TOs. In this case, when a UE finishes a packet transmission and there have several remaining TOs within a CG configuration, the UE can send an information to gNB for indicating the un-used TOs within the CG configuration to avoid a waste of resources. In this case, new UCI type carried by PUCCH and/or CG-UCI can be considered. A detailed design is shown as follows:
Sequence based: a set of values representative of un-used TOs can be configured by RRC, then the UCI is used to indicate a corresponding index (e.g., the UCI is similar to SR), and a default value (e.g., a default offset value) is defined to determine the time location of the un-used TOs. For instance, as shown in FIG. 12, when a UCI indicating the un-used TOs is transmitted, gNB regards the TOs after the default value within the CG as un-used TOs (e.g., TO8, TO9, TO10).
Sequence based: a set of values representative of un-used TOs and a corresponding value K (e.g., an offset value) are configured by RRC, and then the UCI indicates a corresponding index.
Non-sequence based: a new UCI is carried by PUCCH, and the content of UCI includes at least one of the number of unused TOs, the value of K, or the index of unused TOs or a set of unused TOs, etc., where K is used to determine the time location of un-used TOs.
CG-UCI: the content of UCI includes at least one of the following parameters: the number of TOs, the value of K, or the index of a TO or a set of TOs, etc., where K is used to determine the time location of un-used TOs. The number of TOs means number of consecutive or non-consecutive TOs. The number of TOs are used to determine the number of un-used TOs. The value of K is a time unit, and the granularity of the time unit can be slot, symbol, TO duration or ms. It means, from the time location of the signalling, a set of un-used TOs are indicated after K. In some embodiments, the resources (e.g., beta-offset) which are used for carrying CG-UCI can be configurable.
Bitmap: the size of this field is equal to the total number of TOs.
Case 3: Any one or several TOs (except the TOs in the start portion) within a CG configuration are un-used TOs. This is similar to above cases. In this case, bitmap seems suitable.

The above embodiments realize indication of the un-used TOs within a CG configuration which is used to transmit more than one TB, and this can avoid a waste of resources and may avoid extra scheduling delay. Furthermore, these improvements are applicable to XR applications to address the issues of jitter and varying size of XR packet.

Further details on introducing additional TOs after the last TO within the CG configuration are described as follows.

When the TOs within a CG configuration is not enough to transmit all of the TBs of a packet, to reduce the scheduling latency, additional TOs can be added after the last TO within the CG configuration. New UCI or CG-UCI can be used to indicate the additional TOs and can include at least one of the following parameters: an index of a reference TO, the number of TOs that need to be added, the value of K, or an index of a TO, where the index of a reference TO is used to determine all of the parameters of a PUSCH, such as Frequency Domain Resource Assignment (FDRA), TDRA, MCS, etc. If the parameters are not indicated by UCI or CG-UCI, then the default value (a default reference value) can be used, for example, the parameters of the last TO within the CG configuration. The number of TOs is used to indicate the number of additional or supplement TOs, and all of the TOs shares the same parameters of the reference TO or the default value (a default reference value) except HARQ-ID. The value of K is used to indicate a start point in time domain of the additional or supplement TOs.

The above embodiments realize introducing additional TOs after the last TO within the CG configuration which is used to transmit more than one TB, and this can reduce the scheduling latency. Furthermore, these improvements are applicable to XR applications to address the issues of jitter and varying size of XR packet.

Further details on multiplexing multiple UCIs are described as follows.

This disclosure proposes method(s) to handle the rules for multiple UCI multiplexing, including new UCI multiplexing with current types of UCI. In the following, negative new UCI may means the UCI indicates nothing and/or no TOs are indicated as un-used TOs, the positive new UCI may means the UCI indicates some information and/or some TOs are indicated as un-used TOs. Likewise, negative SR may indicate there is no SR to be transmitted while positive SR may carry information of the SR.
Case 1-1: Negative new UCI, negative SR and at most 2 HARQ-ACK information bits in a resource using PUCCH format 0 in a slot or a TO. In this case, UE only transmits the HARQ-ACK using the PUCCH format 0 and the cyclic shift parameter is determined based on HARQ-ACK. When a SR transmission occasion (or the new UCI transmission occasion) is overlapped with at most 2 HARQ-ACK information bits in a resources using PUCCH format 0 in time domain, the UE transmits HARQ-ACK information (sequence) only based on HARQ-ACK parameters and the gNB regards both the SR and the new UCI as negative.
Case 1-2: Negative new UCI, positive SR and at most 2 HARQ-ACK information bits in a TO or slots. In this case, it is based on resources of SR.
Case 1-3: Positive new UCI, negative SR and at most 2 HARQ-ACK information bits in a TO or slots. In this case, it is based on resources of new UCI.
Case 1-4: Positive new UCI, positive SR and at most 2 HARQ-ACK information bits in a TO or slots. In this case, it is based on both resources of SR or new UCI, and cyclic shift value.
Case 2: A PUCCH with positive new UCI and at most 2 HARQ-ACK information bits in a resource using PUCCH format 0 in a slot or a TO. In this case, both new UCI and HARQ-ACK have their cyclic shift values, and the cyclic shift values can be pre-defined. Due to a limit of cyclic shift values, the priority rules can be introduced for handing this case. The following alternatives can be considered.
Alt 1: Regard positive new UCI as high priority and the HARQ-ACK transmission as low priority. UE transmits new UCI using the PUCCH format 0 for new UCI, and the cyclic shift parameter is determined based on new UCI configuration.
Alt 2: Regard HARQ-ACK transmission as high priority and the new UCI report as low priority. UE transmits HARQ-ACK using the PUCCH format 0 for HARQ-ACK, and the cyclic shift parameter is determined based on only HARQ-ACK report parameters.
Alt 3: Regard HARQ-ACK transmission as high priority and the new UCI report as low priority. UE transmits HARQ-ACK using the PUCCH format 0 for HARQ-ACK, and the cyclic shift parameter is determined based on new UCI.
Alt 4: Regard HARQ-ACK transmission as high priority and the new UCI report as low priority. UE transmits HARQ-ACK using the PUCCH format 0 for new UCI, and the cyclic shift parameter is determined based on HARQ-ACK.
Alt 5: Regard HARQ-ACK transmission and new UCI report as the same priority, and introduce a new combination of cyclic shift parameters for combining the new UCI and HARQ-ACK, for instance, as shown in Table 1.

TABLE 1
Mapping of values for one HARQ-ACK information bit and
one new UCI bit to sequences for PUCCH format 0.

| | [HARQ-ACK value, new UCI value] | | | |
|---|---|---|---|---|
| | [0, 0] | [0, 1] | [1, 0] | [1,1] |
| Sequence cyclic shift | m_{CS} = 0 | m_{CS} = 2 | m_{CS} = 7 | m_{CS} = 8 |

Alt 6: UE transmits the PUCCH format 0 and corresponding information which has an early symbol. For instance, if the first symbol of PUCCH format 0 for HARQ-ACK is early than the PUCCH format 0 for new UCI, then UE transmits the HARQ-ACK; if the first symbol of PUCCH format 0 for HARQ-ACK is later than the PUCCH format 0 for new UCI, then UE transmits the new UCI.
Case 3: A PUCCH with new UCI (carrying several bits) and at most 2 HARQ-ACK information bits in a resource using PUCCH format 0 with different priorities in a slot, wherein the priority is configured by gNB. For the case that the new UCI with high priority and the HARQ-ACK with low priority, then UE should report new UCI to the gNB and drop the HARQ-ACK or postpone HARQ-ACK to the next (available) transmission occasion. For the case of the HARQ-ACK with high priority and the new UCI with low priority, the UE should report HARQ-ACK using the PUCCH format 0, and the cyclic shift parameter is determined based on only HARQ-ACK, and the new UCI is drop ped or postponed to the next (available) transmission occasion. In addition, when there is a positive new UCI at the same time, then 1 bit should be added in the behind of HARQ-ACK or new UCI.
Case 4: For the case that UE would transmit new UCI in a resource using PUCCH format 0 and HARQ-ACK information bits in a resource using PUCCH format 1 in a slot, both the new UCI and the HARQ-ACK have the same priority. The priority rules can be introduced to handle this case. The following alternatives can be considered.
Alt 1: Then UE transmits only a PUCCH with new UCI bits in the resources using PUCCH format 0.
Alt 2: Whether UE reports new UCI or HARQ-ACK information is based on the first symbol of each PUCCH format. If the first symbol of PUCCH format 0 is early than PUCCH format 1, then UE transmits only a PUCCH with new UCI information bits in a resource using PUCCH format 0; if the first symbol of PUCCH format 1 is early than PUCCH format 0, then UE transmits only a PUCCH with HARQ-ACK information bits in a resource using PUCCH format 1. If the first symbol of each PUCCH format is the same, UE transmits the information bits using a PUCCH format which has short symbols.
Case 5: For the case that UE would transmit new UCI information in a resource using PUCCH format 1 and up to 2 HARQ-ACK information bits in a resource using PUCCH format 0 in a slot, the new UCI and the HARQ-ACK have the same priority. The priority rules can be introduced to handle this case. The following alternatives can be considered.
Alt 1: UE transmits only a PUCCH with new UCI bits in the resources using PUCCH format 1.
Alt 2: A new cyclic shift value table can be designed to combine the new UCI and HARQ-ACK transmission, using PUCCH format 0 to transmit the combined information.
Case 6: For the case that UE would transmit new UCI in a resource using PUCCH format 1 and at most two HARQ-ACK information bits in a resource using PUCCH format 1 in a slot. Then, UE transmits a PUCCH in the resource using PUCCH format 1 for new UCI information and/or postpones the HARQ-ACK to the next (available) transmission occasion.

Furthermore, the UE transmits a PUCCH for new UCI or HARQ-ACK, which is based on the time location of the PUCCH. If the first symbol of PUCCH format 1 for HARQ-ACK is early than PUCCH format 1 for new UCI, then UE transmits only a PUCCH with HARQ-ACK information bits in a resource using PUCCH format 1. If the first symbol of PUCCH format 1 for new UCI is early than PUCCH format 1 for HARQ-ACK, then UE transmits only a PUCCH with new UCI information bits in a resource using PUCCH format 1. If the first symbol of each PUCCH format is the same and UE transmits the information bits using a PUCCH format which has short symbols.
Case 7: A UE would transmit a PUCCH with HARQ-ACK or CSI or information bits (denotes as M) in a resource using PUCCH format 2 or PUCCH format 3 or PUCCH format 4 and transmit K PUCCHs for respective N bits of new UCI in a slot. The new UCI information bits in a resource are transmitted using PUCCH format 2 or PUCCH format 3 or PUCCH format 4, and then all of the UCIs are connected, and it is regarded as an entity.

The above embodiments realize multiple UCI multiplexing, and multiplexing rules are established between the signalling for indicating the un-used or additional TOs and current UL control information. Therefore, introducing the signalling for indicating the un-used or additional TOs is made implementable, and thus the issues of jitter and varying size of XR packet can be addressed.

Further details on rules for multiplexing multiple UCIs are described as follows.

This disclosure proposes method(s) to handle the rules for multiple UCI multiplexing, including CG-UCI multiplexing with current types of UCI.

In a first possible solution of the present application, the CG-UCI for XR is regarded as having the same or similar priority as CG-UCI for NR-U, and a similar mechanism can be re-used for multiplexing with current UCI. When both CG-UCI for XR and CG-UCI for NR-U are overlapped in time domain, connect the CG-UCI for XR and the CG-UCI for NR-U and regard the connected CG-UCI as an entity.

In a second possible solution of the present application, the CG-UCI for XR is regarded as the highest priority. The CG-PUSCH carries CG-UCI for XR first, then other UCIs.

In a third possible solution of the present application, when a signalling for multiplexing UCIs is enabled, CG-UCI mapping is first in the bit sequence, then other UCIs.

In some embodiments, when the number of UCI types is over 3, drop the CSI, or joint encode CG-UCI and HARQ-ACK bits, or connect two types of CG-UCIs.

The above embodiments realize multiple UCI multiplexing, and multiplexing rules are established between the signalling for indicating the un-used or additional TOs and current UL control information. Therefore, introducing the signalling for indicating the un-used or additional TOs is made implementable, and thus the issues of jitter and varying size of XR packet can be addressed.

Commercial interests for some embodiments are as follows. 1. Solving issues in the prior art. 2. Realizing multiple transmission occasions (TOs) within a CG configuration. 3. Achieving indication of unused resources/transmission occasions within a CG configuration. 4. Avoiding HARQ-ID collision. 5. Enabling multiple UCI multiplexing. 6. Providing a good communication performance. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiments of the present application. For brevity, details will not be described herein again.

The embodiment of the present application further provides a computer program product including computer program instructions. The computer program product enables a computer to execute corresponding processes implemented by the UE/BS in each of the methods of the embodiments of the present application. For brevity, details will not be described herein again.

The embodiment of the present application further provides a computer program. The computer program enables a computer to execute corresponding processes implemented by the UE/BS in each of the methods of the embodiments of the present application. For brevity, details will not be described herein again.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A wireless communication method, performed by a user equipment (UE), the method comprising:
being configured with multiple resources or transmission occasions (TOs) within a configured grant (CG) configuration which is used for transmitting more than one transport block (TB).

2. The method of claim 1, further comprising:
receiving a signaling used to indicate that the number of repetitions is used to determine the number of TOs within the CG configuration.

3. The method of claim 2, wherein the signaling is carried out by a field in downlink control information (DCI) or a column in a Time Domain Resource Allocation (TDRA) field.

4. The method of claim 1, wherein the number of TOs within the CG configuration is indicated by Radio Resource Control (RRC), or by Medium Access Control (MAC) Control Element (CE), or by DCI, or by a TDRA field in DCI.

5. The method of claim 1, wherein the number of TOs within the CG configuration is associated with at least one of the periodicity of CG, the duration of time domain of each TO, the type of Physical Uplink Shared Channel (PUSCH), the number of slots within the periodicity, or the number of repetitions of each TO.

6. The method of claim 1, wherein TBs transmitted over the TOs within the CG configuration are configured with repetition, initial transmissions of different TBs are transmitted first, and the repetition of all the different TBs is transmitted consecutively after the initial transmission in order.

7. The method of claim 1, wherein TBs transmitted over the TOs within the CG configuration are configured with repetition, initial transmissions of different TBs are transmitted first, and all repetitions of one of the different TBs are transmitted consecutively after the initial transmission in order.

8. (canceled)

9. The method of claim 1, wherein each of the TOs within the CG configuration has a different HARQ-ID.

10. The method of claim 9, wherein multiple HARQ-IDs are determined based on a first symbol of each TO of the CG configuration, or the HARQ-IDs of all the TOs within the CG configuration are determined based on a reference HARQ-ID and/or the index/number of a corresponding TO.

11-12. (canceled)

13. The method of claim 1, wherein un-used or used TOs within the CG configuration are indicated by uplink control information (UCI) or CG-UCI or CAS.

14. The method of claim 13, wherein a set of values representative of the un-used TOs is configured by radio resource control (RRC), and the UCI or CG-UCI is used to indicate an index corresponding to one of the set of values representative of the un-used TOs.

15-20. (canceled)

21. The method of claim 13, wherein CG-PUSCH carries the UCI for un-used TO indication first, and then carries other types of UCIs.

22. A wireless communication method, performed by a base station (BS), the method comprising:
configuring a user equipment (UE) with multiple resources or transmission occasions (TOs) within a configured grant (CG) configuration which is used for transmitting more than one transport block (TB).

23-29. (canceled)

30. The method of claim 22, wherein each of the TOs within the CG configuration has a different HARQ-ID.

31. The method of claim 30, wherein multiple HARQ-IDs are determined based on a first symbol of each TO of the CG configuration, or the HARQ-IDs of all the TOs within the CG configuration are determined based on a reference HARQ-ID and/or the index/number of a corresponding TO.

32-33. (canceled)

34. The method of claim 22, wherein un-used or used TOs within the CG configuration are indicated by uplink control information (UCI) or CG-UCI or CAS.

35-40. (canceled)

41. A user equipment (UE), comprising a processor, configured to call and run program instructions stored in a memory, to execute a wireless communication method comprising:
being configured with multiple resources or transmission occasions (TOs) within a configured grant (CG) configuration which is used for transmitting more than one transport block (TB).

42. (canceled)

43. The UE of claim 41, wherein each of the TOs within the CG configuration has a different HARQ-ID.

44. The UE of claim 43, wherein multiple HARQ-IDs are determined based on a first symbol of each TO of the CG configuration, or the HARQ-IDs of all the TOs within the CG configuration are determined based on a reference HARQ-ID and/or the index/number of a corresponding TO.

45. The UE of claim 41, wherein CG-PUSCH carries the UCI for un-used TO indication first, and then carries other types of UCIs.
